(19) United States
(12) Patent Application Publication
(10) Pub. No.: US 2011/0210231 A1
(43) Pub. Date: Sep. 1, 2011

(54) BICYCLE SEAT WITH RESILIENT SUPPORT

(75) Inventor: Christopher P. D'Aluisio, Corralitos, CA (US)

(73) Assignee: SPECIALIZED BICYCLE COMPONENTS, INC., Morgan Hill, CA (US)

(21) Appl. No.: 12/713,732

(22) Filed: Feb. 26, 2010

(51) Int. Cl. F16F 13/04; B62J 1/02

(52) U.S. Cl. 248/629; 297/195.1

(57) ABSTRACT

A bicycle seat support that resiliently supports a bicycle seat. The support comprises an upper engagement member adapted to support a bicycle seat, a lower engagement member adapted to engage a bicycle frame, and a compliant support assembly coupling the upper engagement member to the lower engagement member. The compliant support assembly includes a first and second cantilevered springs defining a gap, and a resilient member (e.g., an elastomer) positioned in the gap. The bicycle seat support can include an elbow joint coupling the lower engagement member to the compliant support assembly. Preferably, the elbow joint comprises an upper portion that sandwiches the first and second cantilevered springs, and a lower portion positioned in a recess in the lower engagement member. The lower engagement member can also include a resilient bump stop adapted to limit downward movement of the upper engagement portion.

### BACKGROUND

The present invention relates to bicycle seats, and particularly to resilient seat supports.

Bicycles commonly have resilient seat supports that cushion the rider from vibrations and bumps while riding. Resilient seat supports commonly include coil springs or resilient pads positioned between a seat and a seat post.

### SUMMARY

The present invention relates to an improved bicycle seat support that resiliently supports a bicycle seat. The support comprises an upper engagement member adapted to support a bicycle seat, a lower engagement member (e.g., a seat post) adapted to engage a bicycle frame, and a compliant support assembly coupling the upper engagement member to the lower engagement member. The compliant support assembly includes a first cantilevered spring (e.g., a leaf spring made of a composite material), a second cantilevered spring (e.g., a leaf spring made of a composite material) having a portion that is spaced from the first cantilevered spring to define a gap, and a resilient member (e.g., an elastomer having a hardness less than the hardness of the first and second cantilevered springs) positioned in the gap.

In one embodiment, the bicycle seat support comprises an elbow joint coupling the lower engagement member to the compliant support assembly. Preferably, the elbow joint comprises an upper portion that sandwiches the first and second cantilevered springs, and a lower portion positioned in a recess in the lower engagement member. The lower engagement member can also include a resilient bump stop adapted to limit downward movement of the upper engagement portion.

Other aspects of the invention will become apparent by consideration of the detailed description and accompanying drawings.

### BRIEF DESCRIPTION OF THE DRAWINGS

FIG. 1 illustrates a side view of a bicycle having a bicycle seat assembly embodying the present invention.

FIG. 2 is a perspective view of the bicycle seat assembly of FIG. 1.

FIG. 3 is an exploded view of the bicycle seat assembly of FIG. 2.

FIG. 4 is a side view of the bicycle seat assembly of FIG. 2.

FIG. 5 is a back view of the bicycle seat assembly of FIG. 2.

FIG. 6 is a side section view taken along line 6-6 in FIG. 5.

FIG. 7 is a section view taken along line 7-7 of FIG. 4.

FIG. 8 is a perspective view of a bicycle seat assembly that is a second embodiment to the present invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

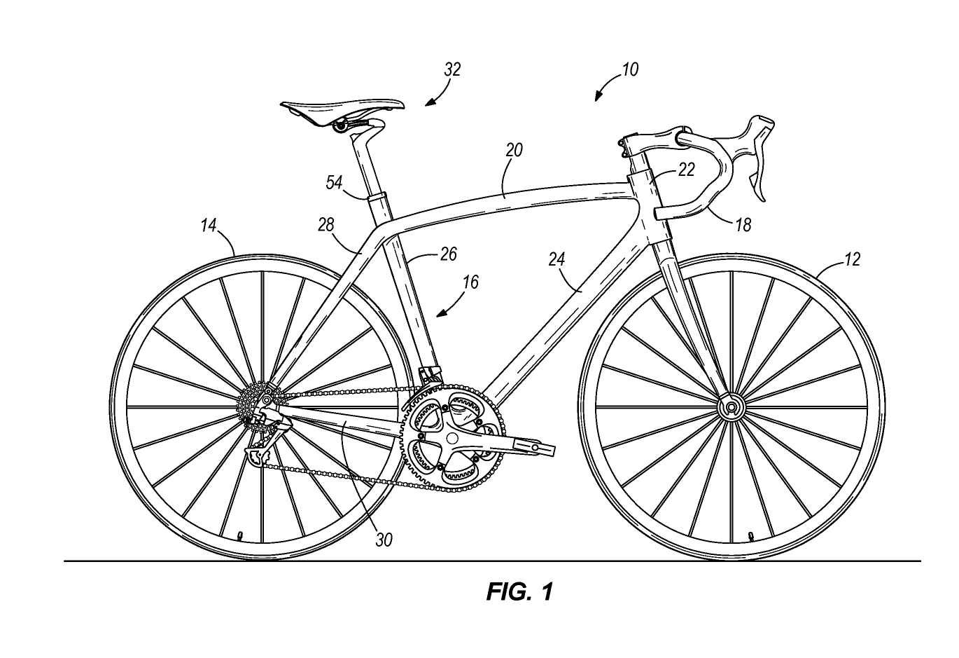

FIG. 1 illustrates a bicycle 10 that includes a front wheel 12, a rear wheel 14, a frame 16, and a steering assembly 18. The frame 16 includes a top tube 20, a head tube 22, a down tube 24, a seat tube 26, seatstays 28, and chainstays 30. A bicycle seat assembly 32 is supported by the frame 16 and provides a surface upon which a rider sits while riding the bicycle 10.

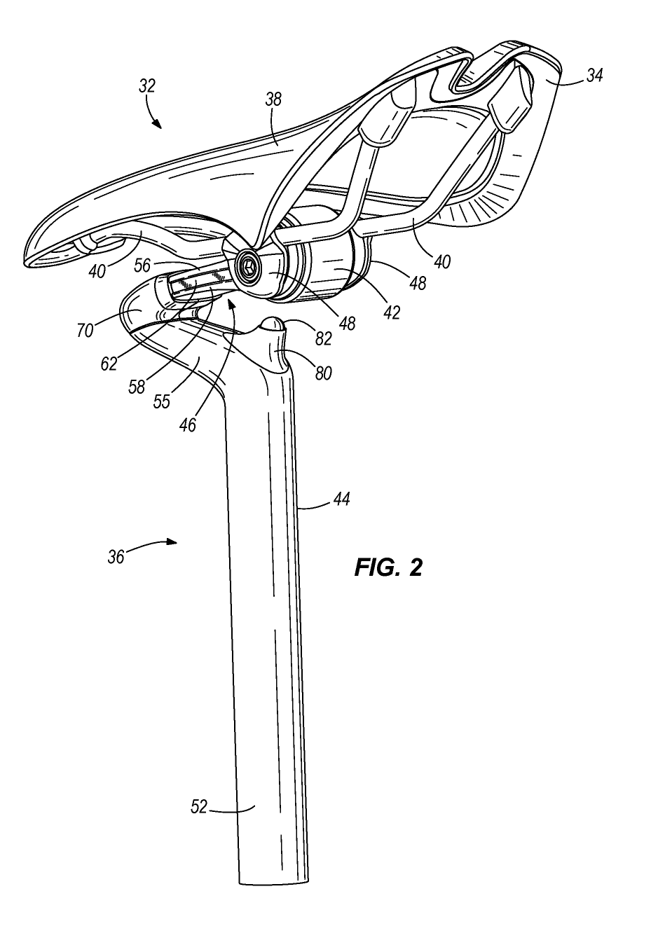

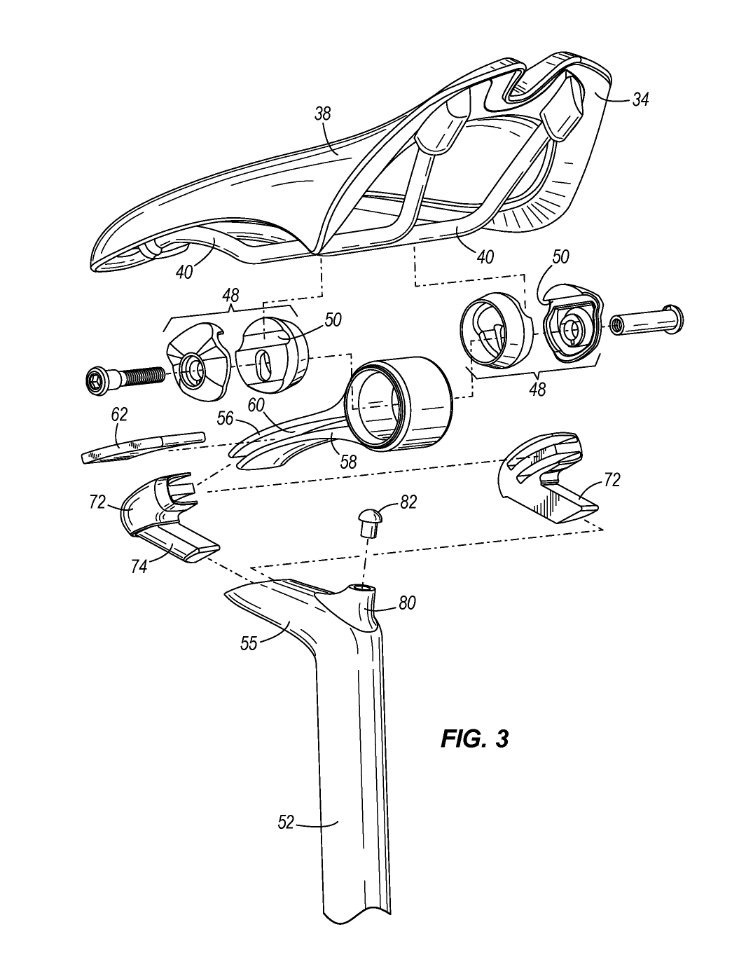

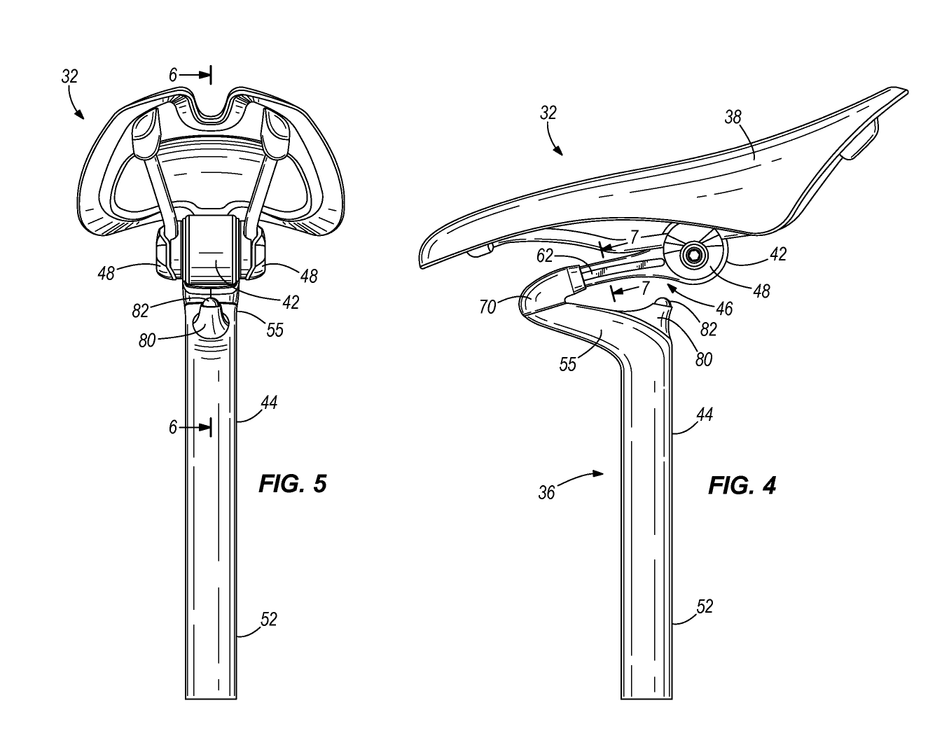

Referring to FIGS. 2-3, the bicycle seat assembly 32 includes a bicycle seat 34 supported by a bicycle seat support 36. The illustrated bicycle seat 34 is a standard seat having a contoured upper surface 38 for supporting the rider, and lower rails 40 adapted to be secured to the bicycle seat support 36.

The bicycle seat support 36 includes an upper engagement member 42 engaged with and supporting the lower rails 40, a lower engagement member 44 secured to and supported by the seat tube 26 of the frame 16, and a compliant support assembly 46 connecting the upper engagement member 42 to the lower engagement member 44. The illustrated upper engagement member 42 includes two pairs of clamp members 48 that define longitudinal recesses 50 for receiving and clamping the lower rails 40 of the bicycle seat 34. The illustrated lower engagement member 44 comprises a seat post 52 secured inside the seat tube 26 of the frame 16 by a clamp 54 (FIG. 1). The seat post includes an upper portion 55.

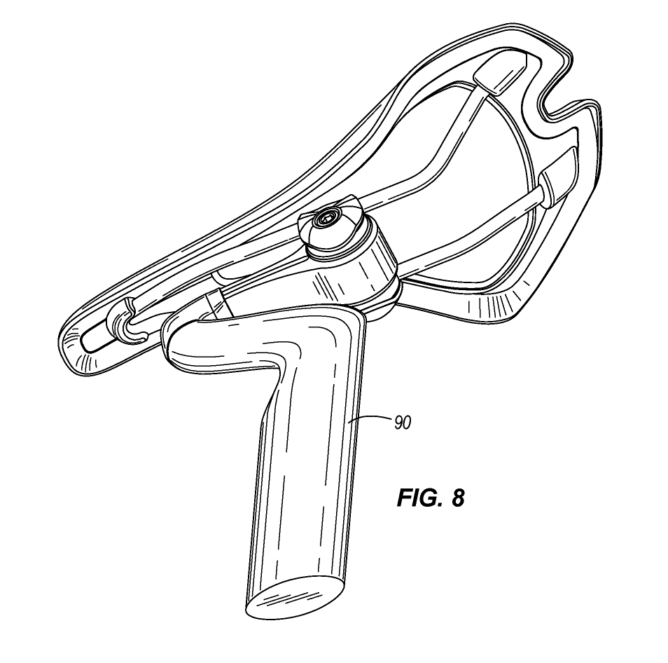

The illustrated compliant support assembly 46 includes a first cantilevered spring 56, a second cantilevered spring 58 spaced from the first cantilevered spring to define a gap 60 (FIG. 3), and a resilient member 62 positioned in the gap. Each of the first and second cantilevered springs 56, 58 comprises a composite material (e.g., carbon fibers in an epoxy matrix) that is sufficiently flexible to resiliently support a rider positioned on the bicycle seat 34. The resilient member 62 provides additional resilient support to the bicycle seat 34. The illustrated resilient member 62 comprises a polyurethane elastomer having a hardness less then the hardness of the cantilevered springs 56, 58. The resilient member 62 can be removed from the gap 60 by the user so that a different resilient member can be used. For example, if the resilient member 62 becomes damaged or worn, a replacement resilient member can be substituted. Alternatively, if it is desired to achieve a different resiliency, a resilient member having a different stiffness can be used. For example, if it desired to increase the stiffness of the compliant support assembly 46, a resilient member having less resiliency can be substituted into the gap 60. In the illustrated embodiment, the resilient member 62 is held in place through an interference fit between the resilient member 62 and the first and second cantilevered springs 56, 58 (FIG. 7). Alternatively, the resilient member 62 can be held in place in any other appropriate manner, such as using fasteners or adhesive.

In the illustrated embodiment, the first and second cantilevered springs 56,58 are positioned substantially parallel to the ground when the bicycle seat support 36 is secured to the frame 16 (see FIG. 1). By virtue of this orientation, flexing of the cantilevered springs 56,58 results in primarily vertical movement of the seat 34, and very little horizontal movement of the seat 34.

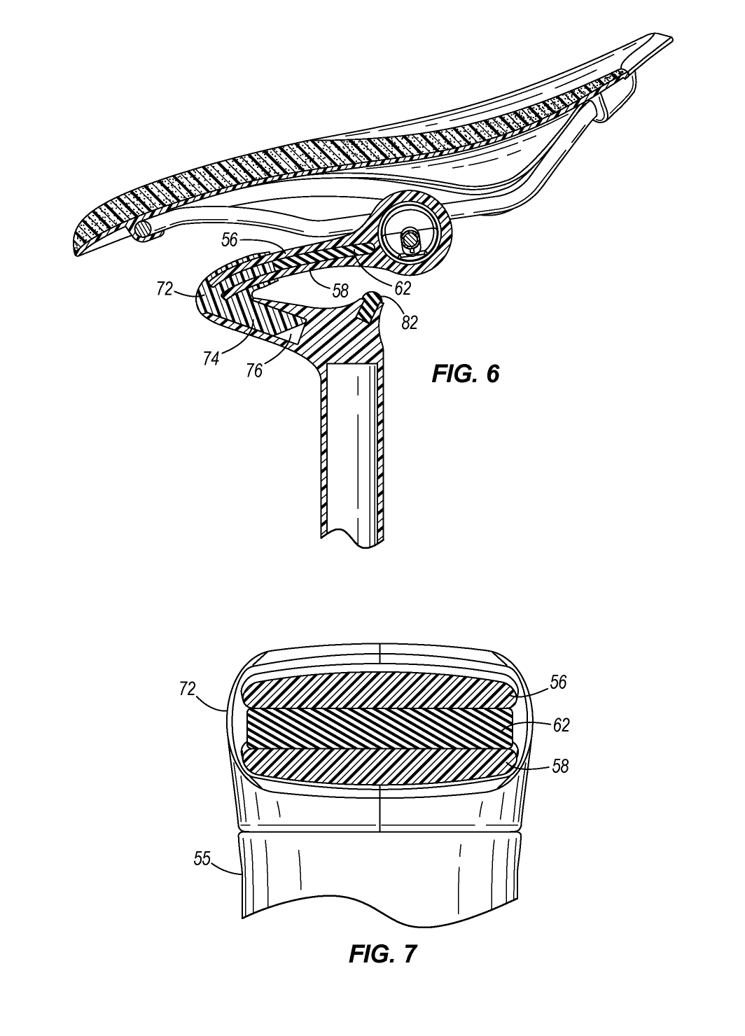

The compliant support assembly 46 is secured to the lower engagement member 44 by an elbow joint 70. The elbow joint 70 includes left and right halves 72 that are secured together to sandwich the first and second cantilevered springs 56, 58. In the illustrated embodiment, the left and right halves 72 are adhesively bonded together and to the first and second cantilevered springs 56, 58. When fully assembled, the elbow joint forms a lower portion 74 that is positioned in a recess 76 (FIG. 6) in the upper portion 55 of the seat post 52. In the illustrated embodiment, the lower portion 74 of the elbow joint 70 is adhesively bonded into the recess 76 of the seat post 52.

The upper portion 55 of the seat post 52 further includes a raised bump stop 80 that limits downward movement of the bicycle seat 34. More specifically, the bump stop 80 comprises a resilient pad 82 that will engage either the upper engagement member 42 or the second cantilevered spring upon extreme downward movement of the bicycle seat 34 relative to the seat post 52. This resilient pad 82 cushions this extreme downward movement of the bicycle seat 34.

Various features and advantages of the invention are set forth in the following claims.

1. A bicycle seat support comprising:
an upper engagement member adapted to support a bicycle seat;
a lower engagement member adapted to engage a bicycle frame; and
a compliant support assembly coupling the upper engagement member to the lower engagement member, the compliant support assembly including:
a first cantilevered spring;
a second cantilevered spring having a portion that is spaced from the first cantilevered spring to define a gap; and
a resilient member positioned in the gap.

2. A bicycle seat support as claimed in claim 1, wherein the lower engagement member comprises a seat post adapted to be inserted into a seat tube of a bicycle frame.

3. A bicycle seat support as claimed in claim 1, wherein the first cantilevered spring is positioned substantially parallel to a ground surface when the seat support is secured to the bicycle frame.

4. A bicycle seat support as claimed in claim 1, wherein the first and second cantilevered springs comprise leaf springs positioned substantially parallel to each other in spaced relation.

5. A bicycle seat support as claimed in claim 4, wherein the leaf springs comprise a fiber-matrix composite material.

6. A bicycle seat support as claimed in claim 1, wherein the resilient member comprises an elastomer.

7. A bicycle seat support as claimed in claim 6, wherein the elastomer comprises a hardness less than the hardness of the first and second cantilevered springs.

8. A bicycle seat support as claimed in claim 1, further comprising an elbow joint coupling the lower engagement member to the compliant support assembly.

9. A bicycle seat support as claimed in claim 8, wherein the elbow joint comprises an upper portion that sandwiches the first and second cantilevered springs.

10. A bicycle seat support as claimed in claim 9, wherein the lower engagement member comprises a recess, and wherein the elbow joint comprises a lower portion positioned in the recess.

11. A bicycle seat support as claimed in claim 1, wherein the lower engagement member comprises a resilient bump stop adapted to limit downward movement of the upper engagement portion.

12. A bicycle seat support comprising:
an upper engagement member adapted to support a bicycle seat;
a lower engagement member adapted to engage a bicycle frame; and
a compliant support assembly coupling the upper engagement member to the lower engagement member, the compliant support assembly including:
a cantilevered spring; and
an elbow joint coupling the cantilevered spring to the lower engagement member, the elbow joint having two pieces that sandwich the cantilevered spring.

13. A bicycle seat support as claimed in claim 12, wherein the lower engagement member comprises a seat post adapted to be inserted into a seat tube of a bicycle frame.

14. A bicycle seat support as claimed in claim 12, wherein the elbow joint comprises an upper portion that sandwiches the first and second cantilevered springs.

15. A bicycle seat support as claimed in claim 14, wherein the lower engagement member comprises a recess, and wherein the elbow joint comprises a lower portion positioned in the recess.

16. A bicycle seat assembly comprising:
a bicycle seat;
an upper engagement member supporting the bicycle seat;
a lower engagement member adapted to engage a bicycle frame;
a compliant support assembly coupling the upper engagement member to the lower engagement member; and
a bump stop positioned to limit movement of the seat toward the seat post.

17. A bicycle seat assembly as claimed in claim 16, wherein the bump stop is secured to the lower engagement member.

18. A bicycle seat assembly as claimed in claim 16, wherein the bump stop comprises a resilient pad.
